(19) United States
(12) Patent Application Publication
(10) Pub. No.: US 2005/0203900 A1
(43) Pub. Date: Sep. 15, 2005

(54) Associative retrieval system and associative retrieval method

(75) Inventors: Takahiro Nakamura, Tokyo (JP); Yoichi Inagaki, Tokyo (JP)

Correspondence Address: OSHA LIANG L.L.P., 1221 MCKINNEY STREET, SUITE 2800, HOUSTON, TX, 77010, US

(73) Assignees: Shogakukan, Inc., Tokyo (JP); CAC Corporation, Tokyo (JP)

(21) Appl. No.: 11/074,322

(22) Filed: Mar. 7, 2005

(30) Foreign Application Priority Data
Mar. 8, 2004 (JP) 2004-064478

(51) Int. Cl. G06F 17/30

(52) U.S. Cl. 707/5

(57) ABSTRACT

A method and system for retrieving information from a set of documents using one retrieval keyword or more is capable of remarkably increasing the relevance ratio of a retrieval result. The system includes a category dictionary for storing category information containing morphemes included in the documents in a hierarchical structure, a morpheme-ID array produced by converting the set of documents into a set of fixed-length IDs in accordance with the morphemes while maintaining order information of the morphemes, and a retrieval part for retrieving a morpheme ID from the morpheme-ID array. The retrieval part retrieves a morpheme ID of the retrieval word and of any morpheme co-occurring with the retrieval word and having category information which matches retrieval-category information.

### BACKGROUND OF THE INVENTION

1. Field of the Invention

The present invention relates to a system and method for easily retrieving documents which meet a retrieval purpose with high retrieval precision from the Internet, namely a set of Web pages, from a corpus, namely a set of texts, and the like.

2. Description of the Related Art

In general, searching the Internet is carried out by retrieving from databases using one retrieval keyword or more. These databases are built in advance and hold indexes, i.e., relationships between various keywords and the URLs of the Web pages including the keywords. The URLs are displayed on a client screen as a retrieval result. However, when retrieval is carried out simply using one retrieval keyword or more, the resultant output usually includes too many retrieval hits. Also, even if associative retrieval or fuzzy reference is used, the number of retrieval hits tends to increase. This is because an emphasis tends to be put on elimination of retrieval omissions. That is to say, importance is attached to an increase in a so-called a recall ratio, which is a ratio of the number of documents actually retrieved to the number of suitable documents to be retrieved.

However, this tendency results in a low relevance ratio, which indicates the number of documents relevant to a retrieval purpose among the number of documents retrieved. It has therefore become difficult to obtain documents which match a retrieval purpose in spite of a high hit number of a retrieval result. Accordingly, although various improvements, such as displaying a Web page having a large number of linked incidences in the first place, have been provided, retrieval precision itself has not been improved. Thus, a result of retrieval remains in a state including a large number of noises.

One of the reasons for the noise occurrence is that word orders and relationships with the other words are not considered in retrieval processing. Thus, documents in a field which is completely different from a retrieval purpose are also retrieved as long as those documents contain the retrieval keywords. Furthermore, another reason is that since one word usually has a plurality of meanings, a result of retrieval sometimes includes cases where a word is used in a different meaning from a retrieval purpose although the word has the same notation as that of a retrieval word. For example, a “Japanese radish” in the Japanese language has both the meanings of a kind of “vegetable” and an “unskilled” actor.

Up to now, a similar-document retrieval system for displaying documents having a high similarity to an input retrieval text has been disclosed (for example, refer to Japanese Unexamined Patent Application Publication No. 2001-84252). In this system, a similarity between an input retrieval text and documents included in a cluster of document databases is calculated in accordance with a tree structure of a similarity concept of independent words included in the documents in order to increase retrieval precision. However, documents having almost the same content as that of the retrieval text are still retrieved by this system, and omissions still increase too much. Also, although a natural language text is allowed for a retrieval text and a free query form is permitted in addition to a normal sentence, it is not possible to answer a question starting with an interrogative such as why?, what?, where?, etc. Thus, a retrieval method by such calculation of similarities is inappropriate for finding-type information retrieval and associative retrieval.

Also, another retrieval method for narrowing down retrieval results has been disclosed (for example, refer to Japanese Unexamined Patent Application Publication No. 2000-148780). In this method, full-text retrieval is performed on a retrieval target document using an input keyword. Then, character strings which include that keyword and have a greater length than that of the keyword are generated from the retrieval result to be shown to the user. Next, the retrieval result is narrowed down using a character string selected by the user. However, no reference for selecting a character string is shown to the user and the result depends on that selection in this method. Also, the retrieval speed is not satisfactory. Furthermore, although conditions for narrowing down are increased by generating longer retrieval character strings, the candidates for selection also increase drastically. Thus, there is the possibility of omitting an appropriate candidate, and it becomes necessary to select a plurality of strings. This makes the operation of the retrieval very troublesome.

A method for checking co-occurrences among words in the entire set of documents has been studied and used in the field of language research even though the method is used in a limited range. In this regard, the co-occurrence refers to a simultaneous occurrence of a plurality of words in a relative vicinity in one text or document, such as in the case of a co-location, etc. In the field of a language research, the co-occurrence has been used for checking a grammatical relationship between words, namely the usage of words, the frequencies of various usage of words that occurs in the document.

However, in order to obtain co-occurrences of a keyword and the peripheral words thereof from a large amount of documents such as Web pages on the Internet, it becomes necessary to perform a vast amount of calculation. Thus, it is virtually impossible to directly apply a method such as grep, etc., which is used in a language research, etc. Also, a method in which co-occurrences for typical representative words are calculated in advance in order to create a co-occurrence table is considered. However, when a large amount of document files such as the Internet and thesis databases are targeted, operations such as addition, update, and deletion occur quite frequently. It is therefore unrealistic to create a co-occurrence table in advance. Moreover, it is not allowed to deal with a retrieval demand such as using co-occurrence relationships among three words or more in this method.

### SUMMARY OF THE INVENTION

Accordingly, one or more embodiments of the present invention provide a system and method which is capable of remarkably increasing the relevance ratio of a retrieval result and swiftly retrieving the target documents. Specifically, the present invention can reflect a field of the document including a retrieval word and the semantic context of the documents on a retrieval result with high retrieval precision, namely at a low noise.

According to a first aspect of an embodiment of the present invention, there is provided a retrieval system for retrieving information from a set of documents using one retrieval word or more, the system including: a category dictionary for storing category information containing morphemes included in the documents in a hierarchical structure; a morpheme-ID array produced by converting the set of documents into a set of fixed-length IDs in accordance with the morphemes while maintaining order information of the morphemes; and a retrieval part for retrieving a morpheme ID from the morpheme-ID array, wherein the retrieval part outputs parts of documents including the retrieval word and a morpheme co-occurring with the retrieval word and having category information matching retrieval-category information.

Here, the retrieval-category information is preferably selected from the hierarchical structure. Furthermore, the retrieval system preferably includes a known-morpheme dictionary storing category information containing the morphemes. Also, when the retrieval-category information is specified by a specific example, the retrieval category is preferably identified with reference to the known-morpheme dictionary. Also, the retrieval system preferably includes an unknown-morpheme dictionary storing a morpheme not stored in the known-morpheme dictionary furthermore. Also, the unknown-morpheme dictionary is preferably processed as one piece of the category information of the category dictionary. Also, the co-occurring morpheme is preferably a morpheme within a range of a predetermined number of grammatical units before and after the retrieval word. Also, independent morphemes occurring adjacently in the document are preferably processed by being concatenated as the co-occurring morphemes. Also, the retrieval system preferably includes means for selecting a method of calculating a degree of co-occurrence for each of the co-occurring morphemes furthermore. Also, the retrieval part preferably calculates a degree of co-occurrence for each of the co-occurring morphemes by a method preselected and outputs a retrieval result in the order of the calculated degree of co-occurrence. Also, all the dictionaries, the arrays, and the retrieval part are preferably loaded into a memory for operation when retrieval processing is performed. Also, conjugation information of the morphemes is preferably included in the fixed-length ID.

According to a second aspect of an embodiment of the present invention, there is provided an input screen of the retrieval system wherein the input screen includes an input window of the retrieval word and an input window of the retrieval category information.

According to a third aspect of an embodiment of the present invention, there is provided an output screen of the retrieval system wherein the retrieval word, the retrieval category information, and the co-occurring morphemes are displayed. Here, the retrieval word, the retrieval category information, and the co-occurring morphemes are preferably displayed, and the co-occurring morphemes are preferably displayed in accordance with the calculated degree of co-occurrence. Also, the output screen preferably includes part of the document including the co-occurring morphemes furthermore. Also, the retrieval word and category information containing the co-occurring morphemes are preferably displayed. Also, the retrieval word is displayed, and category information containing the co-occurring morphemes is preferably displayed in accordance with the degree of co-occurrence.

According to a fourth aspect of an embodiment of the present invention, there is provided a method of retrieving information from a set of documents using one retrieval word or more, the method including the steps of: using a category dictionary for storing category information containing morphemes included in the documents in a hierarchical structure and a morpheme-ID array produced by converting the set of documents into a set of fixed-length IDs in accordance with the morphemes while maintaining order information of the morphemes, retrieving a morpheme ID from the morpheme-ID array; and obtaining a retrieval result by the morpheme IDs of the retrieval word and of any morpheme co-occurring with the retrieval word and having category information matching retrieval-category information.

According to a fifth aspect of an embodiment of the present invention, there is provided a retrieval program for causing a computer to retrieve information from a set of documents using one retrieval word or more, the program including: a category dictionary for storing category information containing morphemes included in the documents in a hierarchical structure; a morpheme-ID array produced by converting the set of documents into a set of fixed-length IDs in accordance with the morphemes while maintaining order information of the morphemes; and a retrieval part for retrieving a morpheme ID from the morpheme-ID array, wherein the retrieval part outputs parts of documents including the retrieval word and a morpheme co-occurring with the retrieval word and having category information matching retrieval-category information.

According to a sixth aspect of an embodiment of the present invention, there is provided a computer-readable recording medium storing the program described above.

### BRIEF DESCRIPTION OF THE DRAWINGS

FIG. 1 is a conceptual diagram schematically illustrating an overall configuration of a retrieval system;

FIG. 2 is a conceptual diagram illustrating an example of a data structure of a known-word dictionary;

FIG. 3 is a conceptual diagram illustrating an example of a data structure of a category-attribute dictionary;

FIG. 4 is a conceptual diagram illustrating an example of a data structure of an unknown-word dictionary;

FIG. 5A is a conceptual diagram illustrating an example of the format of a known-word fixed length ID;

FIG. 5B is a conceptual diagram illustrating an example of the format of an unknown-word fixed length ID;

FIG. 6 is a general flowchart illustrating the processing in a conversion-to-morpheme-ID part;

FIG. 7 is a general flowchart illustrating the processing in a corpus/index generation part;

FIG. 8 is a flowchart illustrating a retrieval-selection process;

FIG. 9 is an example of a client screen for related-term retrieval;

FIG. 10 is another example of a client screen for related-term retrieval;

FIG. 11 is still another example of a client screen for related-term retrieval;

FIG. 12 is a general flowchart illustrating an overall related-term retrieval process;

FIG. 13 is a flowchart illustrating a sub-process in the related-term retrieval process;

FIG. 14 is a flowchart illustrating another sub-process in the related-term retrieval process;

FIG. 15 is a flowchart illustrating still another sub-process in the related-term retrieval process;

FIG. 16 is an example of a client screen for related-category retrieval;

FIG. 17 is a general flowchart illustrating an overall related-category retrieval process;

FIG. 18 is a flowchart illustrating a sub-process in the related-category retrieval process;

FIG. 19 is a flowchart illustrating another sub-process in the related-category retrieval process;

FIG. 20 is a general flowchart illustrating an overall context-retrieval process; and

FIG. 21 is a flowchart illustrating a sub-process in the context-retrieval process.

### DESCRIPTION OF THE PREFERRED EMBODIMENTS

Below, a description will be given of embodiments of the present invention with reference to the drawings. The Japanese language is used as an example of the language of the document to be the target of retrieval. A description will be given on the assumption that the document language is divided into minimum components by a normal morphological analysis. English and the other languages may be used for the documents to be the target of retrieval. In such a case, a word delimited by space may be used as a component. Alternatively, the document may undergo a morphological analysis in the same manner as in the case of the Japanese language, and thus a retrieval system may be constructed in the same manner as the following description. In this regard, a description will be given mainly of the case where morpheme IDs are words included in the body text of a document for the sake of simplicity. However, morpheme IDs may include, for example, document information, etc., included in header information, etc., in addition to the body text of a document.

In related-term retrieval, which is one type of the retrieval provided by an example of the retrieval system described below, one retrieval word or more and information related to a retrieval category to be retrieved are input into the retrieval system. The retrieval is performed based on this input. The retrieval result to be obtained are the morphemes occurring (co-occurring) relatively in the vicinity of a retrieval term and included in a category related to the retrieval category.

For example, when documents are retrieved by selecting “cancer” as a retrieval word and by selecting “medical drug” as a retrieval category, such a document in which an independent word, etc., including morphemes contained in the category of a medical drug occurs relatively near the word “cancer” is retrieved. Such an independent word, etc., is considered to be, for example, a general name or a proper name of a medical drug. That is to say, it is highly possible that documents including medicines for human cancer are retrieved. In a retrieval system incorporating a concept of co-occurrence like this, it is possible to reflect the semantic content possessed by a document on the retrieval result as a consequence. In the following, a description will be given of a retrieval system capable of such retrieval together with a description of a method of retrieval.

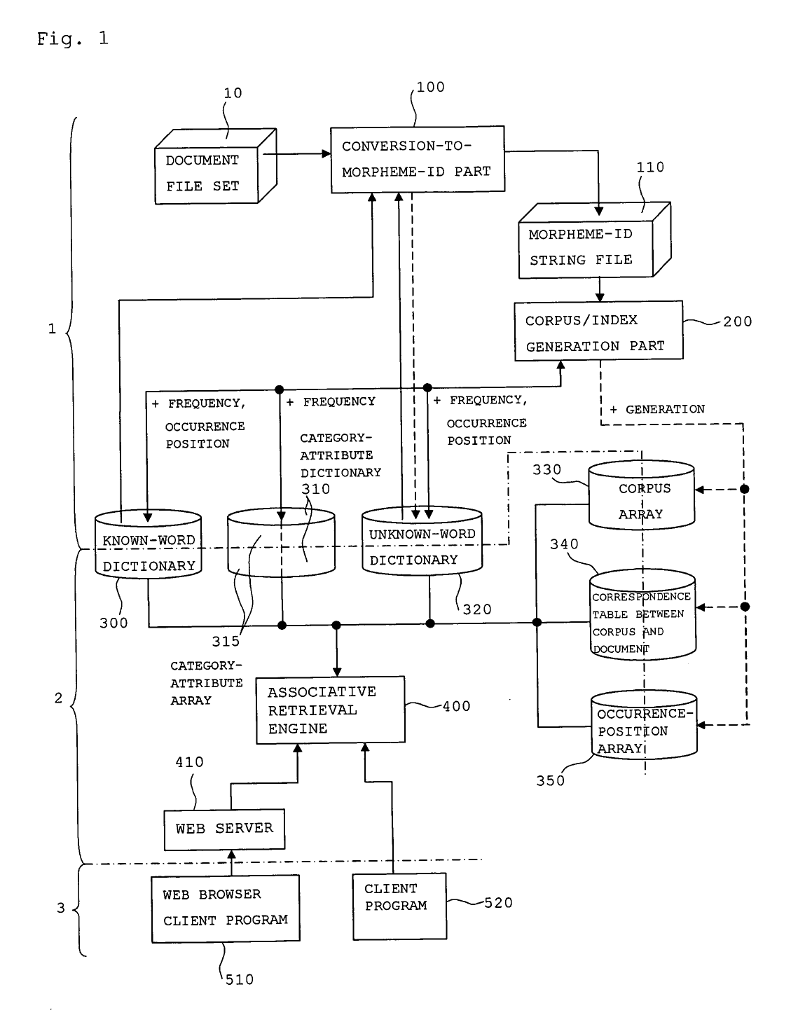

FIG. 1 is a conceptual diagram schematically illustrating an overall configuration of a retrieval system. The retrieval system includes a data-construction part 1 which provides various data such as dictionaries, arrays, corresponding tables, etc., used for associative retrieval in advance, a retrieval part 2 which executes associative retrieval using various data provided in the data-construction part 1, a client part 3 which sends a retrieval instruction to the retrieval part 2 and receives a retrieval result.

First, a description will be given of various data used for associative retrieval. The data includes a known-word dictionary 300, a category-attribute dictionary 310, a category-attribute array 315, an unknown-word dictionary 320, a corpus array 330, a correspondence table between corpus and document 340, an occurrence-position array 350, etc.

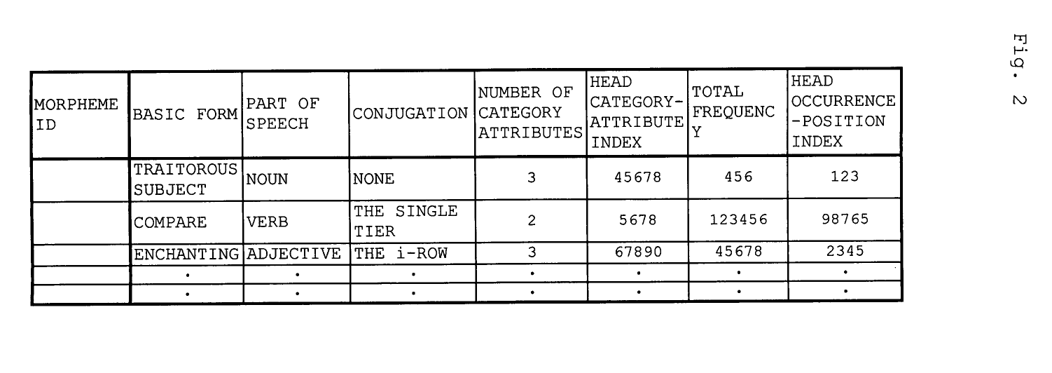

The known-word dictionary 300 is a dictionary of words which have known lexical information such as a basic form, a part of speech, a conjugation, etc., and known category information of the semantic content of each of the words. An example of this dictionary is shown in FIG. 2. The category information refers to, for example, information on variations of the semantic content of a “Japanese radish” such as a “vegetable”, a “skill” of acting, etc., in the case of a word “Japanese radish”. Specifically, the category information includes category-attribute IDs such as a “vegetable”, a “skill”, etc., and the number of category attributes indicating the number of the category-attribute IDs. The details of these meanings will be described in connection with the category-attribute array 315 described below. Also, the known-word dictionary 300 stores information on the positions and the frequencies of the occurrences of that morpheme in the corpus array 330 described below for each morpheme. This is data on the total number of frequencies and the head occurrence-position indexes. Specific meanings of these will be described in detail in connection with the description of the occurrence-position array 350 described below.

The data in the known-word dictionary 300 needs to be provided in advance except the total number of frequencies and a head occurrence-position index. The total number of frequencies and the head occurrence-position index are determined by a corpus/index generation part 200.

In this manner, it is possible to retrieve information which reflects the semantic content of a word by including category information on the semantic content of the word in advance. The category information may include a category on things such as medicine, fertilizer, paintings, etc., and may be a category on an abstract category other than things such as law, reputation, politics, illness, etc. Also, the category information may include a category which classifies a word representing evaluation and judgement such as light in weight, beautiful, pretty, etc., and may include any category to be a retrieval target. Moreover, since the known-word dictionary 300 include frequency information of words in advance, it is possible to obtain degrees of various co-occurrences described below to use them for display. For example, it is possible to obtain common-sense co-occurrence by simple frequency and to retrieve a relatively rare co-occurrence having a low occurrence frequency by an MI score.

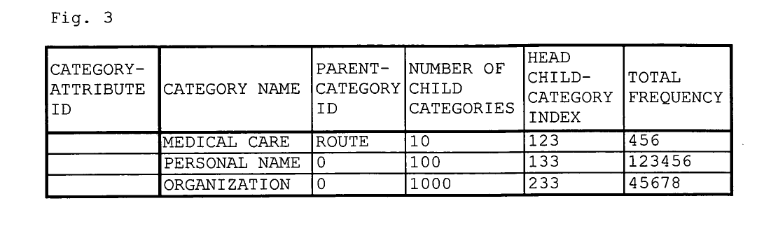

The category-attribute dictionary 310 is a dictionary for holding each category information when categories are summarized in a hierarchical structure. An example of this dictionary is shown in FIG. 3. The category-attribute dictionary 310 stores a category-attribute ID, a category name, a parent-category ID, the number of child categories, a head child-category index, and a total number of frequencies for each category.

The parent-category ID identifies a category which is a parent of the target category attribute. In this regard, a category attribute has only one parent, and has a hierarchical tree structure. The number of child categories is the total number of subordinate categories located immediately under a target category. The head child-category index is a first child-category index in a category-attribute array out of subordinate categories. The same number of elements as the number of child categories are the immediate child categories from that index. Also, the total number of frequencies means frequencies of the occurrences of the words included in that category in a set of document files. In a category-attribute dictionary, all items except the total number of frequencies need to be provided in advance. The total number of frequencies is determined by the corpus/index generation part 200.

In this manner, since the category dictionary is provided in advance, it is possible to perform retrieval in accordance with the semantic content of the field to be retrieved. Also, since data indicating a parent-child relationship and a relationship between categories of words are provided in advance, it is possible to perform retrieval of related categories.

The category-attribute array 315 is an array in which category-attribute IDs are arranged in one dimension. The category-attribute IDs to which that morpheme belongs are arranged for each morpheme. In order to get the category-attribute IDs to which a specific word belongs, it is necessary to have the head occurrence position of the portion where the category-attribute IDs of that word are located and the number of the consecutively located category-IDs. The number of category-attributes in the known-word dictionary 300 is this consecutive number and the category-attribute index is an index indicating the head occurrence position.

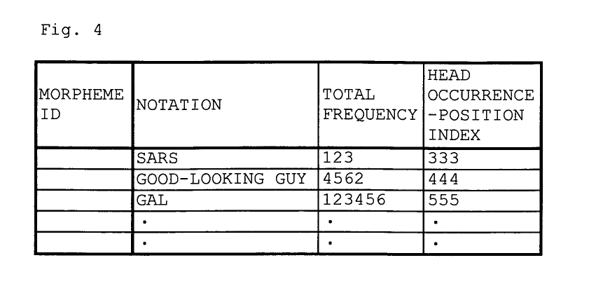

The unknown-word dictionary 320 stores words that are not contained in the known-word dictionary 300 as needed among the words in a set of document files. An example of the unknown-word dictionary 320 is shown in FIG. 4. The unknown-word dictionary 320 includes a morpheme ID, a notation, a total number of occurrence frequencies in the set of document files, and an index of the occurrence-position array. A description will be given below of the total frequencies and the head occurrence-position index similarly with the known-word dictionary 300. A conversion-to-morpheme-ID part 100 writes morpheme IDs and notations into the unknown-word dictionary 320 as needed. The corpus/index generation part 200 creates a hash table using the notation as a key and using an unknown-word ID as a value from the unknown-word dictionary 320. The total number of frequencies of an unknown word is counted and data is generated into the occurrence-position array using this hash table, and they are stored into the unknown-word dictionary 320.

New information which has been unknown up to now often occurs in connection with an unknown word. Thus, the unknown-word dictionary 320 is important. For example, a name of a new drug for cancer, etc., often has a strong possibility to be katakana (one of the Japanese syllabary systems) and unknown. However, unknown words are not limited to katakana and may be Chinese words and alphabet strings. Also, an unknown-word dictionary 320 is useful when looking up a semantic word which is not included in the known-word dictionary because the word has been newly used recently. By providing such an unknown-word dictionary 320, it becomes possible to include an unknown word for the retrieval target.

The corpus array 330 is an array which concatenates morpheme-ID string files that are the equivalent morpheme-ID strings produced by converting individual documents in a set of all the document files including the word order with inserting a delimiter code for each document. The name of this array is attached because the content of the array is similar to a corpus in a language research. The corpus array 330 is created by the corpus/index generation part 200.

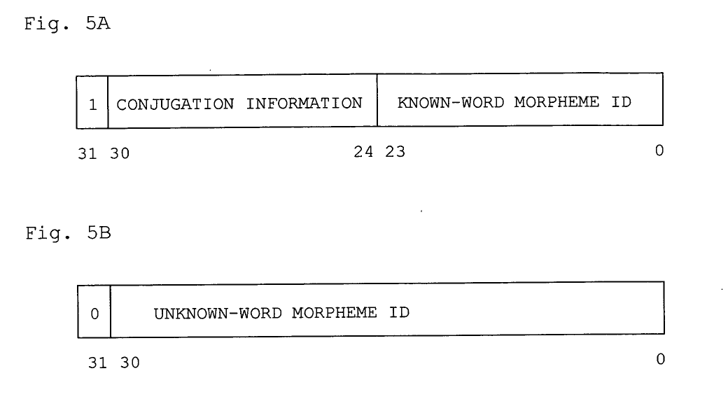

Here, a morpheme ID is assumed to have a 32-bit fixed-length record. The morpheme ID has two kinds of formats, one format is for a known word, and the other is for an unknown word. These formats are shown in FIGS. 5A and 5B. FIG. 5A and FIG. 5B are a format for a known word and a format for an unknown word, respectively. For a known word, 7-bit field of the morpheme ID is assigned to conjugation code information. In the case of the Japanese language, the number of the kinds of conjugation forms (the plain negative form, the continuative form, etc.) for each conjugation type (the five-tier conjugation of a Japanese verb, the two-tier conjugation of a Japanese verb, etc.) is about 20 at the maximum. Thus, a minimum of five bits is sufficient for representing the conjugation. However, 7 bits are assigned to conjugation information in consideration of application to the other languages. In contrast, information on the conjugation form, etc., for an unknown word is not known, and thus a part for the conjugation information is not provided as a known word. In this manner, when one word is coded by a 32-bit length code, the size of a corpus array becomes (the total number of words+the number of documents+1)×4 bytes. In this regard, the fixed-length is not limited to 32 bits. Any convenient length code may be used.

By providing a corpus array having such a fixed-length ID record, it becomes possible to count the number of words among each word easily, and thus it becomes remarkably easy to perform co-occurrence calculations.

The occurrence-position array 350 is provided for indexing a word registered in the known-word dictionary 300 or the unknown-word dictionary 320 in order to indicate the location of the occurrence of that word in the corpus array 330. The element of the array is an index of an occurrence position in the corpus array. The occurrence-position array 350 is constructed by summarizing indexes of occurrence positions for each word. Using the occurrence-position array 350, the occurrence positions of all the words in the corpus array 330 can be identified by head occurrence-position indexes of the words and the total number of frequencies, namely the number of occurrences of the word. The occurrence-position array 350 is created by the corpus/index generation part 200.

The correspondence table between corpus and document 340 is a table for storing a corresponding relationship between information which uniquely identifies a document such as an URL and a starting position of that document in the corpus array. This table is sorted in an ascending order of the start positions in the corpus array. A retrieval engine 400 is capable of obtaining a corresponding document information from any index of the corpus array using this data.

Next, a description will be given of the data-construction part 1. The data-construction part 1 includes the conversion-to-morpheme-ID part 100 which converts a set of document files 10 into fixed-length ID strings while holding word-order information, the corpus/index generation part 200 which identifies the occurrence frequency and the occurrence positions of each morpheme using the fixed-length ID string to generate data necessary for associative retrieval, and a storage part necessary for processing. The set of document files 10 is a set of documents. The fixed-length ID strings produced by the conversion of the set of document files 10 is a set of the converted documents, which correspond to the original documents with a one-to-one relationship individually.

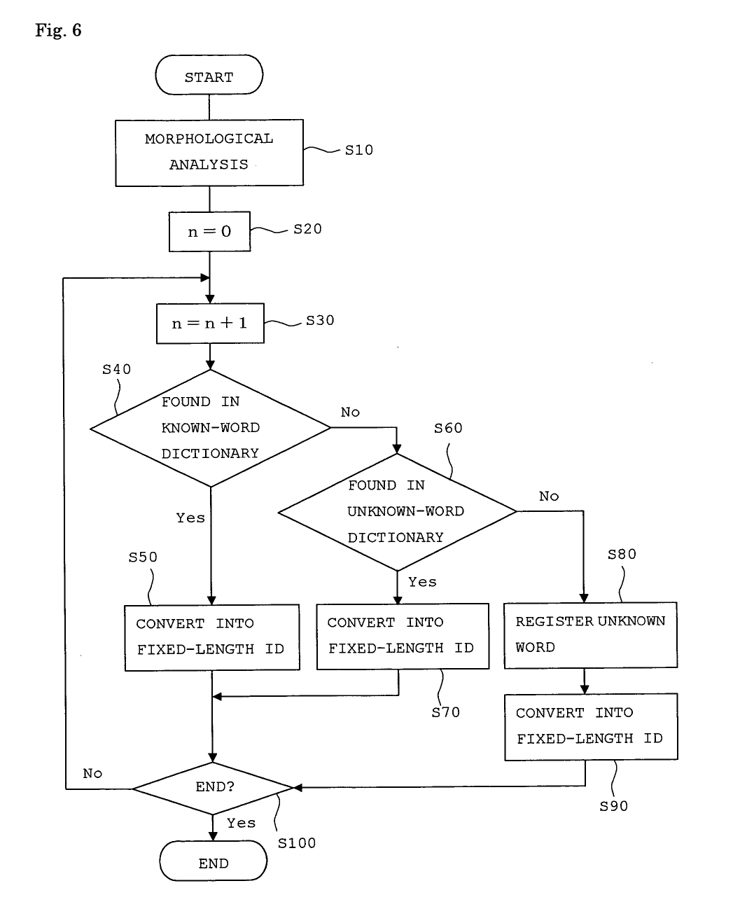

A description will be given of the processing in the conversion-to-morpheme-ID part 100 using a flowchart in FIG. 6. The conversion-to-morpheme-ID part 100 performs normal morphological analysis on a document file to be a retrieval target such as a document on the Internet and a corpus to decompose the document into morphemes (step S10). The order of the morphemes in the document is maintained as the order in the document at that time without change. Next, the head morpheme in a document file is selected (steps S20 and S30). Next, for the selected morpheme, reference is made to the known-word dictionary 300 shown in FIG. 2 in order to determine whether or not the selected morpheme is stored in the known-word dictionary 300 (step S40). If the selected morpheme is stored in the known-word dictionary 300, the selected morpheme is converted into a morpheme ID in the known-word dictionary 300 (step S50) and proceeds to step S60.

If the selected morpheme is not stored in the known-word dictionary 300 in step S40, the selected morpheme is regarded as an unknown word. The processing branches to the right from step S40 and the retrieval is performed from the unknown-word dictionary 320 shown in FIG. 4 in order to determine whether there is the selected morpheme in the unknown-word dictionary 320 or not (step S60). The unknown-word dictionary 320 stores words that have been determined to be unknown words in the documents already captured in a fixed-length 32-bit format in the same manner as the morpheme IDs of the known words. A morpheme ID of an unknown word, which is different from a known word, is given to the unknown word and is stored in the unknown-word dictionary 320 with the morpheme ID being connected with the notation of the word.

In step 60, if the unknown word is stored in the unknown-word dictionary 320, the processing branches downward, that unknown word is converted into the morpheme ID stored in the unknown-word dictionary 320 (step S70), and the processing proceeds to step S100. On the other hand, if the unknown word is not stored in the unknown-word dictionary 320 in step S60, the processing branches to the right, a new unknown-word fixed ID is given to that unknown word and is registered in the unknown-word dictionary 320 as a new unknown word (step S80). The number of occurrence frequencies and the head occurrence-position indexes are created by the corpus/index generation part 200. Next, that unknown word in the document is converted into the fixed-length ID of the unknown word, which is newly given (step S90), and the processing proceeds to S100.

In step S100, a determination is made as to whether or not all the morphemes in the document file have been converted into morpheme Ids. That is to say, a determination is made as to whether or not the processing has reached the end of the document file. If the processing has not reached the end, the processing branches to the left to go back to step S30, selects the next morpheme in the word order, and repeats the processing from step S40 to step S100. If the processing has reached the end of the document file in step S100, the processing branches downward to be terminated.

In this manner, the document of the retrieval target is converted into the 32-bit fixed-ID strings. Thus, a morpheme-ID string file 110 is produced. This file is a fixed-length ID string including each morpheme of each document, which is originally undefined length, is expressed by fixed-length ID while maintaining the order of each morpheme in the document on the assumption of using the known-word dictionary 300 and the unknown-word dictionary 320.

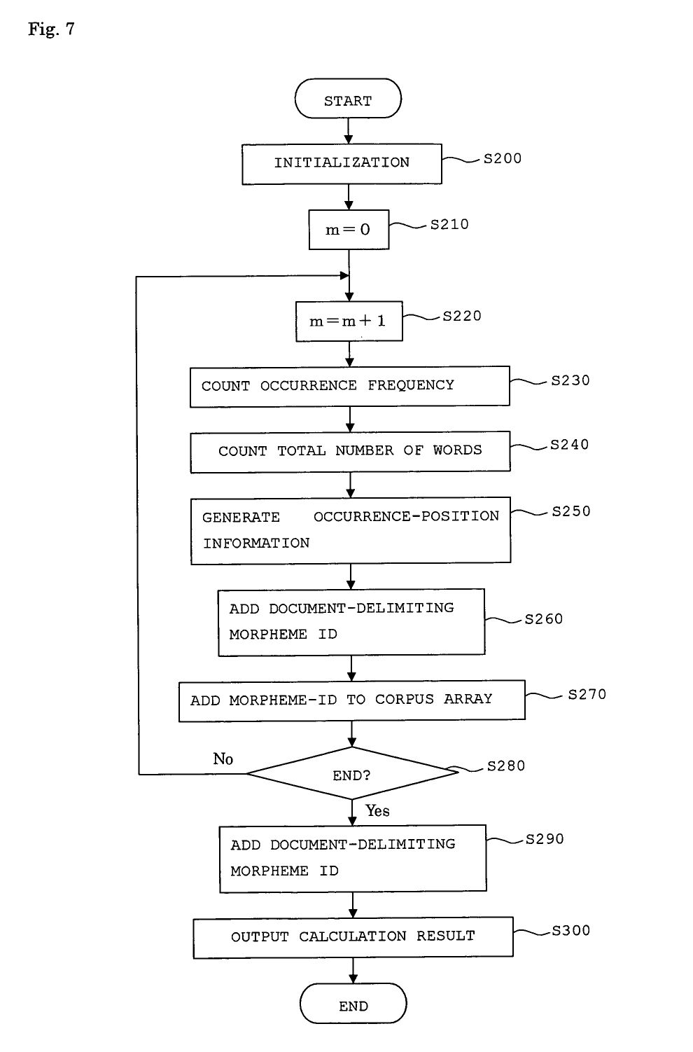

Next, a description will be given of the corpus/index generation part 200. The corpus/index generation part 200 provides necessary data for associative retrieval using the morpheme-ID string file 110, which is the fixed-length ID string produced by the conversion-to-morpheme-ID part 100. Specifically, the corpus/index generation part 200 obtains frequency information and occurrence-position information in the document file of each morpheme with reference to the known-word dictionary 300, the category-attribute dictionary 310, and the unknown-word dictionary 320 to output them to the corpus array 330, the correspondence table between corpus and document 340, and the occurrence-position array 350. Furthermore, the corpus/index generation part 200 outputs additional data to the known-word dictionary 300, the category-attribute dictionary 310, and the unknown-word dictionary 320. A description will be given of the processing in the corpus/index generation part 200 using a flowchart in FIG. 7.

When the processing is started, initialization is performed first, and then the known-word dictionary 300, the category-attribute dictionary 310, and the unknown-word dictionary 320 are loaded into the memory (step S200). Next, one document file is selected and read from the morpheme-ID string file 110 (steps S200 to S210). The number of occurrence frequencies is counted for each morpheme of the document file (step S230) and then the total number of words is counted (step S240). Subsequently, occurrence-position information is created for each morpheme (step S250). Furthermore, a document-delimiting morpheme ID is added to the end of the existing corpus array 330 (step S260), and then the selected morpheme-ID string is added subsequently to the document-delimiting morpheme ID (step S270).

Subsequently, a determination is made as to whether or not all the document files included in the morpheme-ID string file 110 are processed (step S280). If there is an unprocessed document file, the processing branches to the left from step S280 to repeat the processing from step S220 to step S280. If the processing of all the document file is completed, the processing branches downward from step S280, the document-delimiting morpheme ID is added (step S290), the calculation result is stored in each of the dictionaries, etc. (step S300), and the processing is completed.

In this manner, for all the document files to be the retrieval target, the occurrence positions and frequencies of each morpheme and the category containing the word and the frequencies thereof, etc., are identified in advance and are stored in the dictionaries, etc., and the arrays for retrieval are provided. Thus, it is possible to promptly reach the category and the word to be the target. As a result, it is possible to perform associative retrieval described below, and thus it is possible to easily find the documents to be the retrieval target. Also, since the corpus array is constituted by fixed-length ID strings, it is easy to count the number of words, and thus it is possible to incorporate the concept of co-occurrence easily.

Next, a description will be given of the retrieval part 2 of the retrieval system. The retrieval part 2 includes the retrieval engine 400 for executing retrieval using the various data described above, and a Web server 410 provided as needed in order to receive a retrieval request from the Internet and to serve as intermediary with the retrieval engine 400. First, a description will be given of the retrieval engine 400.

The retrieval engine 400 executes retrieval in accordance with instructions from a client using the various data of the dictionaries 300 to 350. The retrieval condition transmitted from a client program to the retrieval engine 400 roughly includes two kinds of sub-conditions. One of the sub-conditions is one retrieval word or more. This may be a single word. Alternatively, this may be a natural language text which is a string of words with a certain meaning. The other is retrieval category information identifying a field to be retrieved. For example, in the case of retrieving a cancer drug, the retrieval category is a medical drug. The retrieval category changes depending on the way of classifying categories. Thus, the category information may be selected from the category-attribute dictionary 310 described below. Also, in the case where the category to be retrieved is not known, but a specific example of a word which belongs to that category is known, the specific word may be input. In the associative retrieval of the retrieval engine 400, retrieval is performed on the assumption of at least these two retrieval sub-conditions.

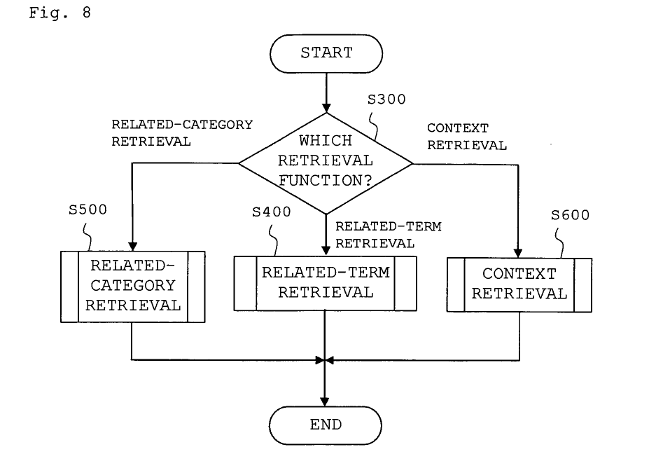

The retrieval engine 400 can execute three kinds of retrieval, namely related-term retrieval, related-category retrieval, and context retrieval. The retrieval can be switched by selecting one of them as needed. The selection processing is shown by the flowchart in FIG. 8. The related-term retrieval is a main retrieval of this retrieval system. The related-category retrieval is sometimes used before related-term retrieval is performed. The context retrieval is sometimes used after the related-term retrieval is performed.

First, in related-term retrieval, a retrieval word is retrieved from a set of documents. Next, a determination is made as to whether there is a word which belongs to the same category as the retrieval category in a range of a certain number of morphemes (words) before and after the retrieval word or not (that is to say, whether co-occurrence occurs or not). If there is such a word, the word is determined to meet the retrieval condition to be displayed to the client in accordance with a certain reference described below. Also, in the context retrieval described below, the retrieval word and part of the documents including the retrieval word are displayed to the client as necessary. In this regard, the range for determining co-occurrence is preferably set to be from one word to 100 words before and after the retrieval word. More preferably, the range is set to be from three words up to about 60 words in advance. The retrieval precision can be adjusted by adjusting the number of words of this range.

The range for determining the co-occurrence may be determined by the number of the grammatical units other than morphemes. For example, the number of characters, the number of sentences, or the number of paragraphs may be used. Although any grammatical units may be used for the determination of co-occurrence, it is simple and preferable to use the number of morphemes. Also, a fixed number may be set to the number of grammatical units used for the determination of co-occurrence in advance as in this example. Alternatively, the number may be dynamically set depending on a part of speech of the retrieval word, a retrieval category, or whether the retrieval word is an unknown word of a known word.

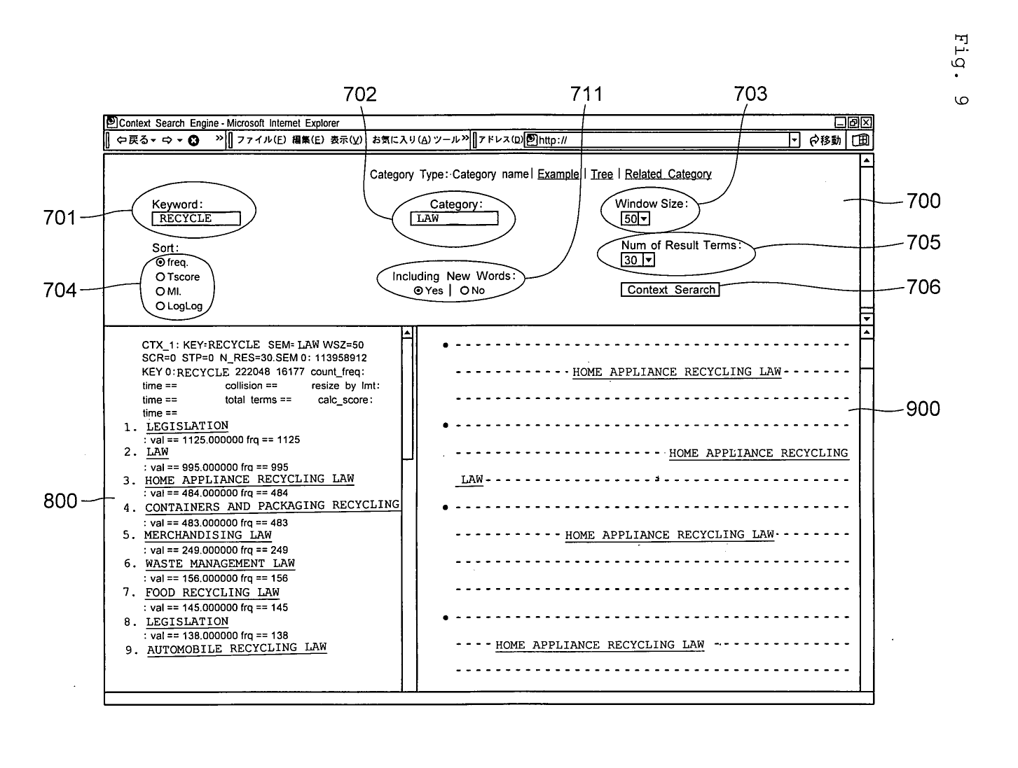

FIG. 9 shows an example of a screen displayed at the client for related-term retrieval. This example screen is formed using a general browser software. The example screen has a screen structure as follows. First, a frame 700 for setting the retrieval condition is contained in the upper part of the screen, and a frame for displaying a retrieval result is contained in the lower part of the screen. Also, a frame 800 for displaying co-occurring morphemes is located in the lower left side of the screen and a frame 900 for displaying part of the sentences including co-occurring morphemes is located in the lower right side of the screen.

The frame 700 for setting the retrieval condition is provided with a window 701 for inputting a retrieval word, a window 702 for inputting a retrieval category, a window 703 for inputting the number of words for determining the range of co-occurring morphemes (displayed as “Window Size” in FIG. 9), a button 704 for selecting a calculation method of co-occurrence (displayed as “Sort” in FIG. 9), a window 705 for selecting the number of displaying the morphemes retrieved, and a button 706 for executing retrieval.

Here, a new-word selection button 711 is a button for specifying whether to select an unknown word which is not stored in the known-word dictionary as one of the categories. This is because information on a part-of-speech and a category is not stored in the unknown-word dictionary 320 and thus there is no data for determining the category of peripheral word co-occurring. Accordingly, a document including an unknown word becomes difficult to be retrieved even the document matches the retrieval purpose. However, unknown words occur in connection with new information, and thus it is desirable for the document including unknown words to be retrieved. For this reason, when the new-word selection button 711 is specified to YES, the unknown-word dictionary 320 is interpreted as one of the categories matching the retrieval category, and the unknown-word dictionary 320 becomes the target of retrieval.

One retrieval word or more including a natural language text is input into the window 701. In this example, “recycle” has been input. When a plurality of words are specified by delimiting by space or a comma, an OR operation is performed on the condition. When “A, B” is specified, retrieval is performed using A or B as an axis of co-occurrence. On the other hand, a concatenation of words which are not delimited by space or a comma (for example, “AB”) is regarded as one retrieval word. Also, the name of a field to be retrieved is directly input into the window 702. In this example, “law” is input. The range of co-occurrence is specified as 50 words before and after the retrieval word by the input into the window 703.

When a retrieval condition is input into the upper frame 700 and retrieval is executed, words are displayed in the lower left frame 800. Also, when one of those words is selected, each part of a plurality of sentences including the selected word are displayed in the lower right frame 900 by the context retrieval described below. In FIG. 9, the sentences are displayed when “home appliance recycling law” is selected.

The retrieval result displayed in the frame 800 shows the words which belong to the category “law” within the range of 50 words before and after the word “recycle” on the basis of a simple frequency (“freq” in “Sort”). In this regard, the units displayed here include a single morpheme such as “law”, and also include “containers and packaging recycling law”, which is one unit by concatenating four independent morphemes, namely container, packaging, recycle, and law.

This is because a plurality of words are often concatenated to have a meaningful expression in an actual language expression. That is to say, when only a minimum unit by morphological analysis is targeted for retrieval, a meaningful expression is not necessarily obtained as a retrieval result. Thus, when there are a plurality of independent adjacent morphemes in a document as described above, these morphemes are all concatenated in principle and are processed as a unit. Here, independent morphemes refer to nouns, adjectives, verbs, etc., and morphemes which are not independent, namely dependent morphemes, refer to a positional word, an auxiliary verb, etc., in the Japanese language. These morphemes should be set in the dictionaries in accordance with the characteristics of a language.

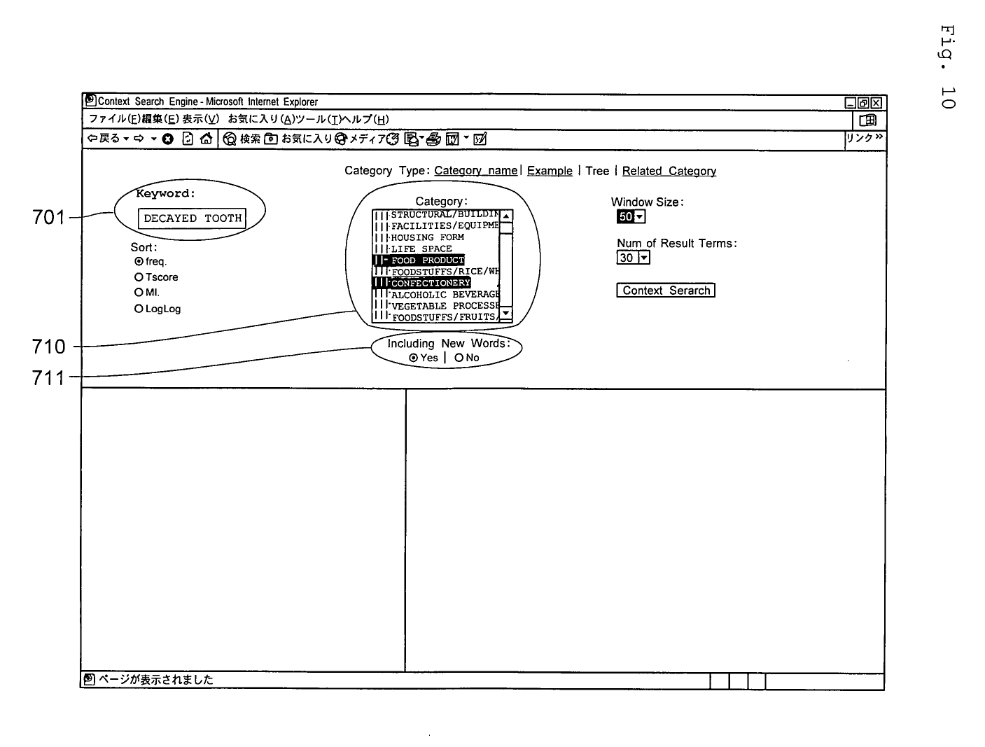

Instead of the window 702 for inputting a retrieval category in the screen in FIG. 9, it is possible to display a hierarchical structure of the category information to allow the user to select the retrieval category. FIG. 10 shows an example of this screen. A category is displayed in a category window 710 with a hierarchical structure.

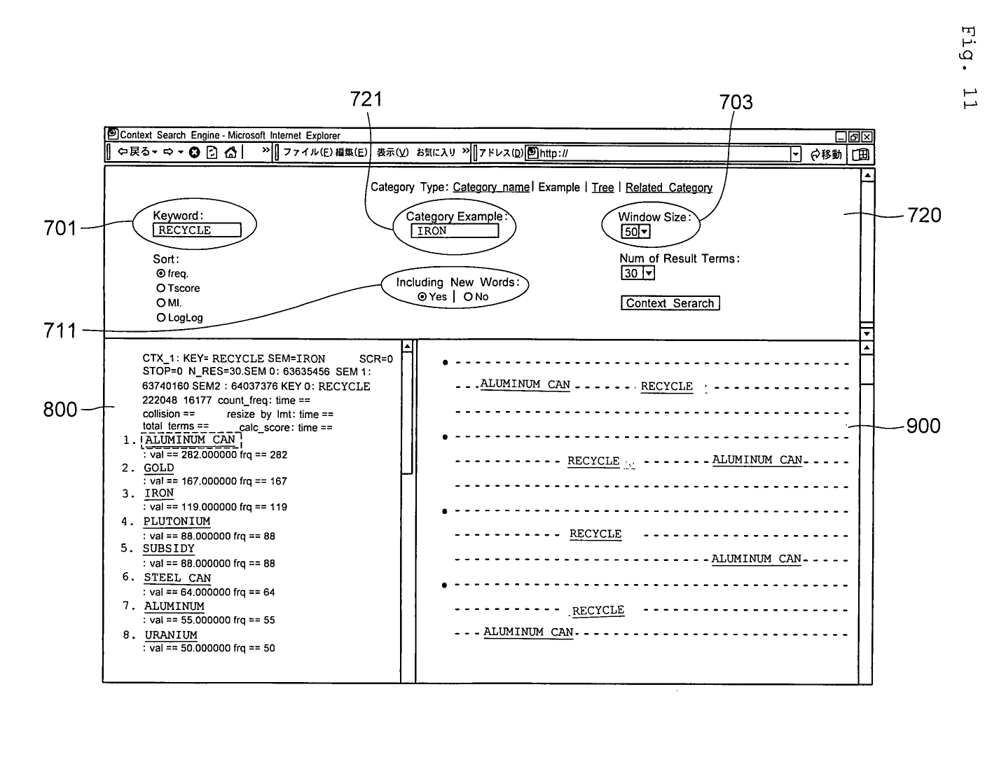

Moreover, it is possible to input a specific example included in a category to be retrieved instead of a category name itself. FIG. 11 shows an example of this screen. In this example, “iron” is input into a specific input window 721. This is input in place of inputting metal as a category. Here, it is possible to input a plurality of words. In the case where a specific example has a plurality of categories, a plurality of categories are used with an OR operation when co-occurring peripheral words are registered.

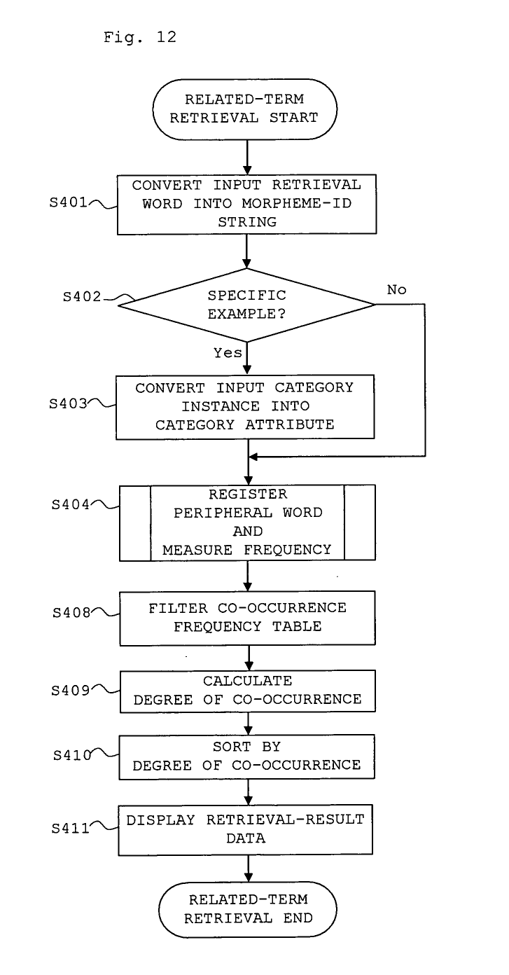

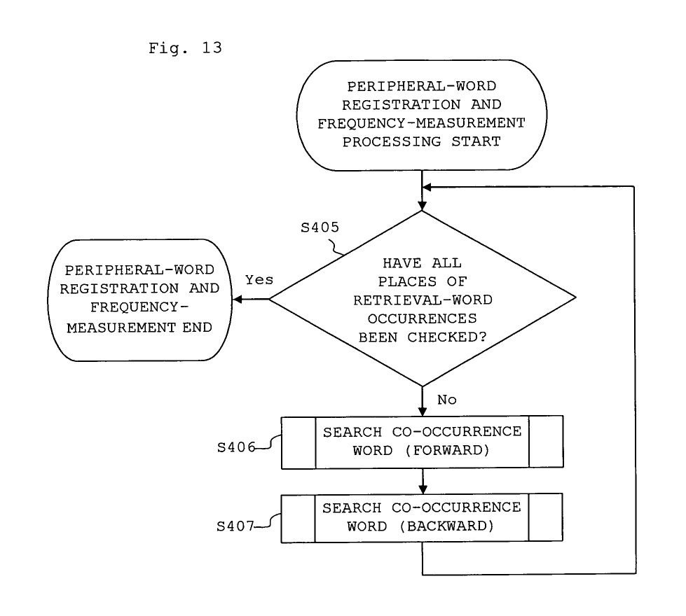

Next, a description will be given of the processing flowchart of the related-term retrieval using the flowcharts in FIGS. 12 to 15. FIG. 12 is a general flowchart illustrating an overall related-term retrieval process. FIGS. 13 to 15 are sub-flowcharts thereof.

First, when the processing starts, an input retrieval word is converted into a morpheme-ID string (step S401). Here, morphological analysis is performed on the input retrieval word to convert the retrieval word into a morpheme-ID string with reference to the dictionaries. Thus, the retrieval word may be a natural language text. When a specific example which belongs to a category is input as an example screen in FIG. 11, it is necessary to retrieve a category from the specific example. In step S402, a determination is made as to whether it is necessary to do so. If a specific example is input, the processing proceeds to the subsequent step S403, the known-word dictionary 300 is referenced, and the specific example is converted into a category-attribute ID. If the retrieval is not by a specific example, the category name input or selected is converted into a category-attribute ID, and the processing proceeds to S404 by skipping step S403.

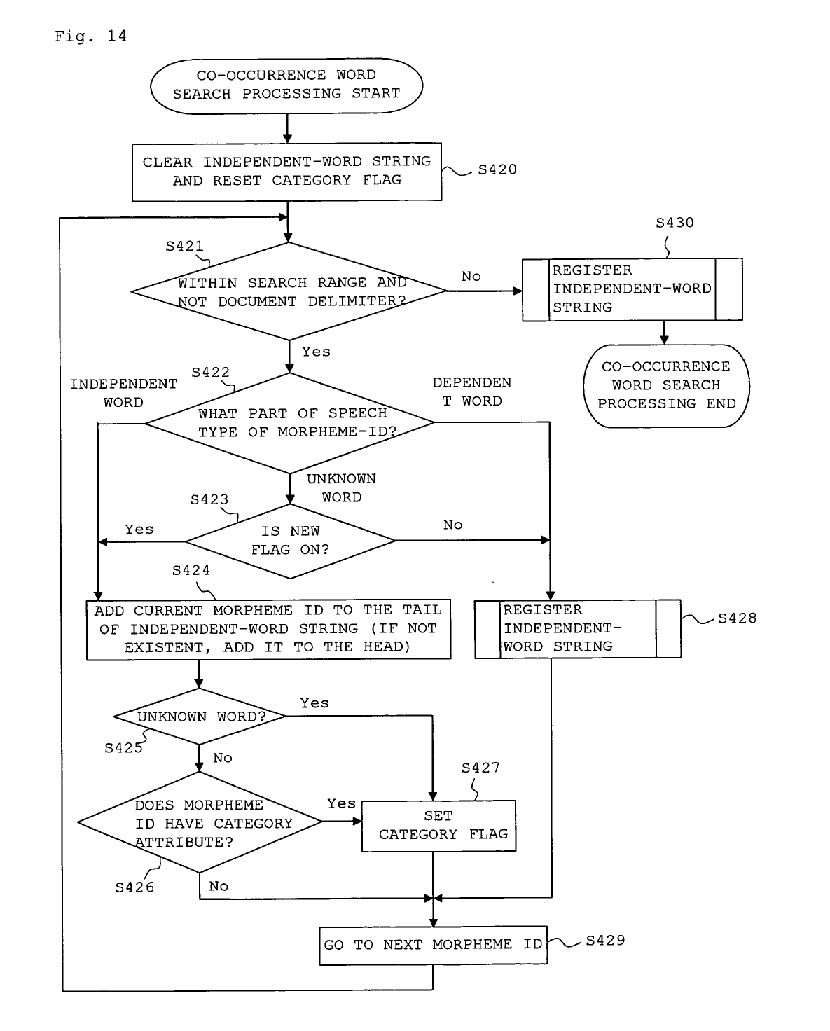

In the subsequent step S404, peripheral words co-occurring with the retrieval word are registered and co-occurrence frequency is measured. This step will be described using the flowchart in FIG. 13. In this processing, all the words co-occurring with the retrieval word within the specified 50 words before and after the retrieval word are captured. First, a determination is made as to whether or not the processing has been performed on all the occurrence positions of the retrieval words obtained from the occurrence-position array 350 (step S405). If there is an unprocessed occurrence position, the peripheral word co-occurring before the retrieval word is retrieved in step S406 and the peripheral word co-occurring after the retrieval word is retrieved in step S407. In steps S406 and S407, although there is a difference in a forward direction and a backward direction, similar processing is performed. Thus, a description will be given of the processing in step S407 using the flowchart in FIG. 14 as an example. In this processing, co-occurring peripheral words are retrieved and if independent words are located adjacently, those words are concatenated to be registered in the co-occurrence frequency table.

Here, the co-occurrence frequency table is a table which is temporarily generated when retrieval is executed in the retrieval part, which is generated as a hash table. This table stores retrieved independent words or retrieved independent word strings, the co-occurrence frequencies thereof, and an occurrence-position list of the retrieved independent words or retrieved independent word strings in the corpus-array.

When the processing in FIG. 14 starts, first, the independent word strings which have been maintained are cleared. One morpheme in a proceeding direction after the retrieval word is selected and a category flag is reset (step S420). In this regard, the category flag is a flag used for determining whether or not each independent word sting includes a morpheme which belongs to a category attribute included in the retrieval category. Subsequently to the initialization processing, a determination is made as to whether the selected morpheme is within a search range, and is not a document delimiter (step S421). In this step, the range of co-occurrence after the retrieval word is identified. If the determination in step S421 is YES, the processing branches downward, the dictionaries are referenced to determine the part-of-speech type of the selected morpheme (step S422).

In the subsequent step S422, if the part-of speech is a noun, a verb, an adjective, etc., of independent type, the processing branches to the left to proceed to step S424. If the part-of-speech is a positional word, an auxiliary verb, etc., of dependent word type, the processing branches to the right to proceed to step S428. If the selected morpheme is an unknown word and no part-of-speech data is available, the processing branches downward from step S422 to proceed to step S423.

In step S423, a determination is made as to whether or not a new-word flag is ON. Here, a new flag is a flag corresponding to the new-word selection button 711 displayed in the screen in FIG. 10. When the new-word selection button 711 is YES, the new flag is set. When the new-word selection button 711 is NO, the new flag is reset. When the new flag is ON, that is to say, when unknown words are included in the retrieval category, the processing proceeds to step S424. On the other hand, when the new flag is OFF, that is to say, when unknown words are not included in the retrieval category, the processing proceeds to step S428.

In step S424, the selected morpheme is an independent word or an unknown word to be retrieved. If an independent word or an unknown word to be retrieved is held in the loop processing from step S421 to S424 and to S429, the selected morpheme is concatenated with the morpheme held. If there is no morpheme held, the selected morpheme is held in the head position. In this manner, as long as independent words and unknown words to be retrieved continue, they are concatenated. In this manner, it becomes easier to obtain a meaningful content in the retrieval result.

In the subsequent step S425, a determination is made as to whether or not the selected morpheme is an unknown word. If it is an unknown word, the processing branches to the right and the category flag of the independent word string including the selected morpheme is set (step S427). In step S425, if the selected morpheme is not an unknown word, the processing proceeds downward to go to step S426.

In step S426, the dictionaries are referenced and a determination is made as to whether or not the category attribute containing the selected morpheme matches the retrieval category. If the selected morpheme matches the retrieval category, the processing branches to the right from step S426, and the category flag of the independent word string including the selected morpheme is set (step S427), and the processing proceeds to step S429. If the selected morpheme does not match the retrieval category, the processing branches downward from step S426 and the processing proceeds to step S429.

That is to say, the category information including one of the morphemes constituting an independent-word string matches the retrieval category, the category flag of the independent-word string is set.

Incidentally, in step S422, if the part-of-speech of the selected morpheme is determined to be a dependent word, that morpheme is not the target of the independent-word concatenation. An independent-word string held by the concatenation by the loop processing in steps S421 to S424, and to S429 is registered in the co-occurrence table in step S428 without concatenating the selected morpheme. Thus, the independent-word string is fixed. In this regard, the details of step S428 will be described later.

In step S429, a morpheme succeeding after the selected morpheme is newly selected. In the following, until it is determined to be NO in step S421, the processing from step S421 to step S429 is repeated. The co-occurrence range after the retrieval word is all covered by this.

In step S421, if it is determined to be NO, the processing has been completed until the end of the co-occurrence range, and thus the processing branches to the right, the independent-word string is registered in the co-occurrence table (step S430), and the processing is terminated.

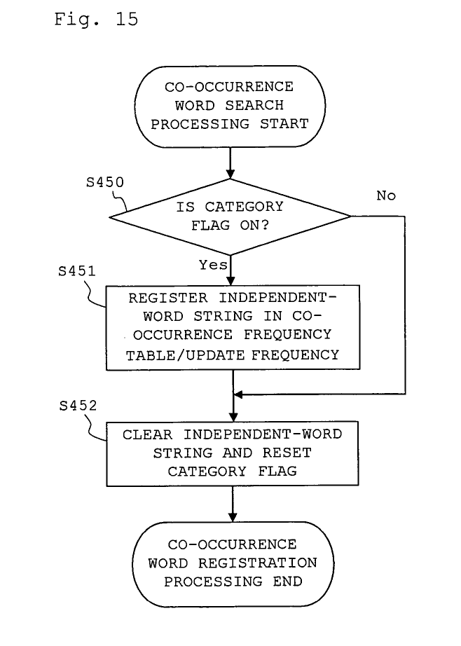

Here, a description will be given of the processing of steps S428 and S430 for registering an independent-word string using a flowchart in FIG. 15. When registration processing of an independent-word string is started, a determination is made on whether or not the category flag is ON (step S450). When the category flag is ON, the category to which any one of the morphemes in an independent-word string belongs is the retrieval category, and thus the processing branches downward. If the independent-word string is not registered, the independent-word string is registered in the co-occurrence table, and the frequency data is updated. When the independent-word string is already registered, the frequency data is simply updated (step S451). Subsequently, the processing proceeds to step S452.

Also, when the category flag is OFF in step S450, any morpheme in the independent-word string is not the retrieval category, and thus the processing skips step S451 to proceed to step S452. In step S452, the independent-word string held is cleared, and the category flag is reset. Thus, the registration processing of the independent-word string co-occurring after the retrieval word, which is executed in step S407, is terminated.

Now, referring back to FIG. 13 from FIG. 14. The processing in step S406 of FIG. 13 is different from that of step S407 only in a direction of retrieval, and thus the order of adding new morpheme to an independent-word string is different. However, the other processing is the same, that is, registration processing of an independent-word string is performed before the retrieval word.

Furthermore, referring back to the flowchart in FIG. 12, the processing proceeds to step S408 from step S404. Here, filter processing is performed on the co-occurrence table in which the above result has been registered. This is because a retrieval result having a low frequency of occurrences such as once or twice is considered to be not useful in general, and thus the filter processing is necessary in order to eliminate these from the retrieval result. In this regard, the criteria for this filtering can be increased and decreased appropriately.

Subsequently, a degree of co-occurrence is calculated for all the independent-words and independent-word strings, which are peripheral words registered in the co-occurrence table, by a selected calculation method (step S409). In an example of this retrieval system, four kinds of methods, namely simple frequency (frequency counts), t-score, MI score (Mutual Information score), and LogLog score are provided for the calculation methods of the degree of co-occurrence. In the example screen in FIG. 9, a button 704 for selecting these is provided, and the calculation method is selected in accordance with the selection. A brief description will be given of these methods. In the calculation of co-occurrence by a simple frequency, a degree of co-occurrence is already obtained in the co-occurrence table, and thus no calculation is required.

The calculation of co-occurrence by t-score is one of the indexes for measuring co-occurrence strength by applying a t-test method. Suppose that the total number of morphemes of the corpus array is Nc. Suppose that the occurrence frequencies in the corpus array of a retrieval word X and a peripheral word Y are Nx and Ny, respectively. Also, assuming that the co-occurrence frequency of X and Y is Nxy, calculation is performed based on the following expression.

$$tscore = \frac{{N}_{XY} - \frac{{N}_{X} \times {N}_{Y}}{{N}_{C}}}{\sqrt{{N}_{XY}}}$$

Here, the total number of morphemes Nc is a constant counted by the corpus/index generation part 200. The frequency Nx of the retrieval word can be counted when occurrence positions of the retrieval word is identified. The frequency Ny of the independent-word strings registered in the co-occurrence frequency table is counted by the same algorithm as fixing the occurrence positions of the retrieval word. The co-occurrence frequency Nxy is obtained from the co-occurrence frequency table.

Next, calculation of the degree of co-occurrence by MI score is obtained by the following expression. The word which connects to the retrieval word characteristically is ranked in an upper position. On the contrary, a high-frequency word which occurs many times in the corpus array is ranked in a lower position. The values Nx, Ny, Nxy, and Nc are obtained in the same manner as the t-score described above.

$$MIscore = {log}_{2} ( \frac{{N}_{XY} \times {N}_{C}}{{N}_{X} \times {N}_{Y}} )$$

The degree of co-occurrence by the LogLog score is obtained by multiplying the MI score and the logarithm of the co-occurrence frequency. This is a calculation method which evaluates co-occurrence frequency more positively. The method give a middle measurement between the simple frequency for considering only a frequency and an MI score for placing a characteristic word in an upper position.
log log score=MIscore×log₂ N_{XY}

Referring back to FIG. 12, the processing proceeds from step S409 to step S410. Here, the independent-words and independent-word strings stored in the co-occurrence frequency table is sorted using the degree of co-occurrence calculated as described above. Thus, when the retrieval result is displayed, the independent-words and independent-word strings which are determined to be more important by the retrieving user are displayed first. Finally, this result is displayed in the screen to terminate retrieval. In this manner, an example of the display screen of the independent-word strings is shown in the frame 800 in the lower left screen in FIG. 9.

Thus, the independent words or independent-word strings are which matches the retrieval category is constituted from the morphemes co-occurring with the retrieval word. In the case of an independent word, one of the categories including the word falls on the retrieval word. Also, in the case of independent-word strings, at least one morpheme which belongs to the retrieval category is included in the morpheme of the strings. Thus, the semantic content to be retrieved can be reflected on the retrieval. Furthermore, an independent-word string which has a high possibility of having a special meaning linguistically is also displayed by this. Thus, it becomes easy to select the intended document and it becomes possible to perform accurate retrieval corresponding to the retrieval purpose. Also, when the retrieval result is displayed, the result is sorted by the selected degree of co-occurrence. Thus, it becomes possible to accurately retrieve a document which meets the retrieval purpose.

By using related-term retrieval, it becomes possible to answer the question in the form, for example, “What are the drugs related to cancer?” For example, “cancer” should be specified for the retrieval word and “medical drug” should be specified for the retrieval category. In this manner, it becomes possible to retrieve independent words and independent-word strings that answer this question. That is to say, it becomes possible to perform retrieval reflecting the semantic content to be retrieved. Also, it is possible to directly refer to sentences including those independent words and independent-word strings by using context retrieval described below at the same time. Thus, it becomes possible to read only the documents that meet the retrieval purpose. Furthermore, unknown related word can be found, and thus it is possible to read completely unknown document.

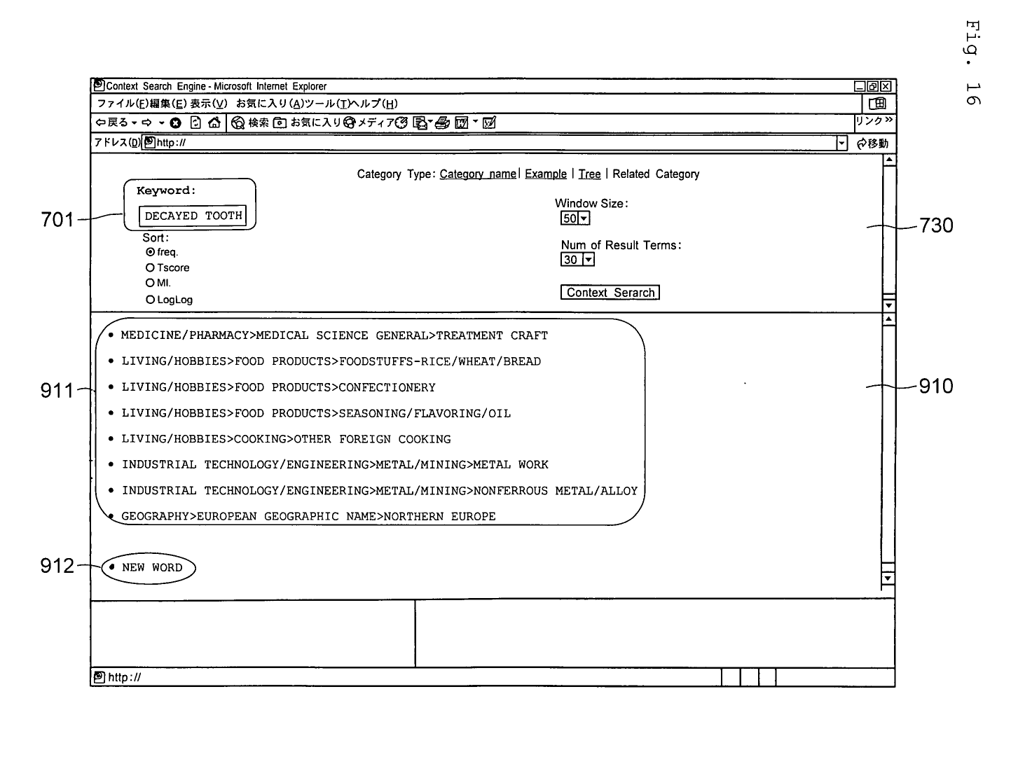

Next, a description will be given of related-category retrieval which is the second retrieval shown by the flowchart in FIG. 8. In this retrieval, retrieval is performed by the category containing peripheral words co-occurring with the retrieval word. This is different from the related-term retrieval which retrieves peripheral words co-occurring with the retrieval word. An example of this retrieval screen is shown in FIG. 16. The structure of the example of the screen is similar to the screen in FIG. 9. However, the difference from the screen in FIG. 9 is that there is no window for inputting a retrieval category in the frame 730. When a retrieval word is input into the window 701, a category 911 to which the peripheral words belong is displayed in the frame 910. In this regard, a heading, new word 912 is displayed under the category 911 here. This is because an unknown word is set to be selected as one category in advance.

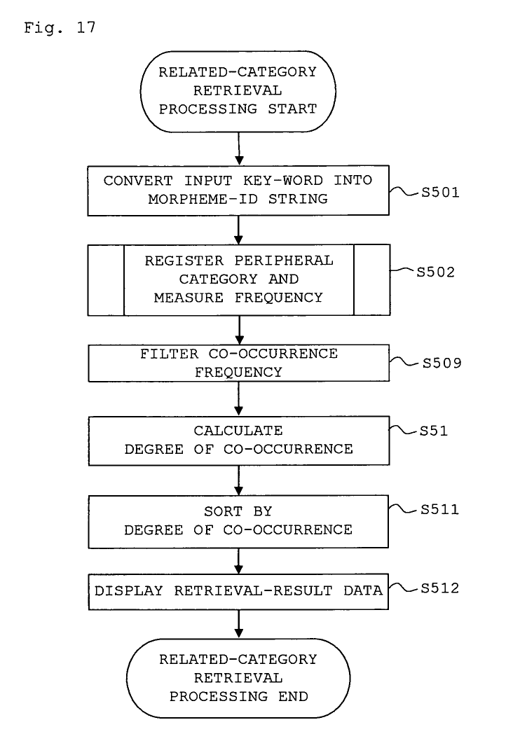

A description will be given of the processing of the related-category retrieval using flowcharts in FIGS. 17 to 19.

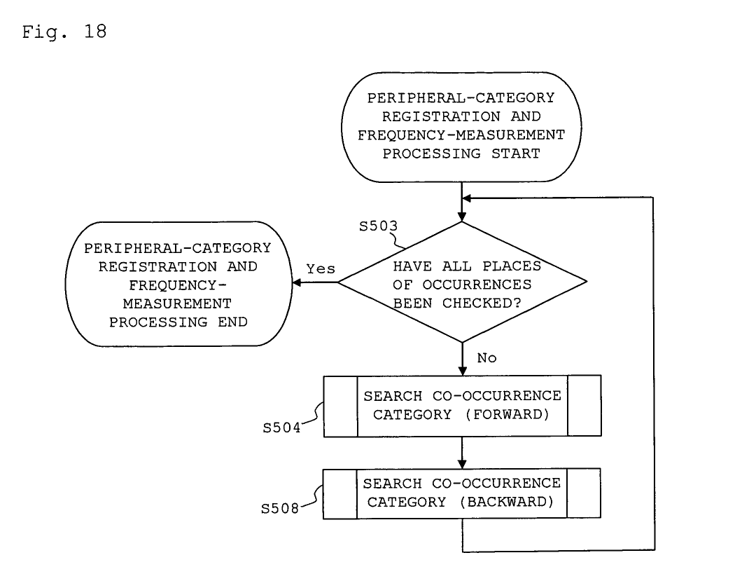

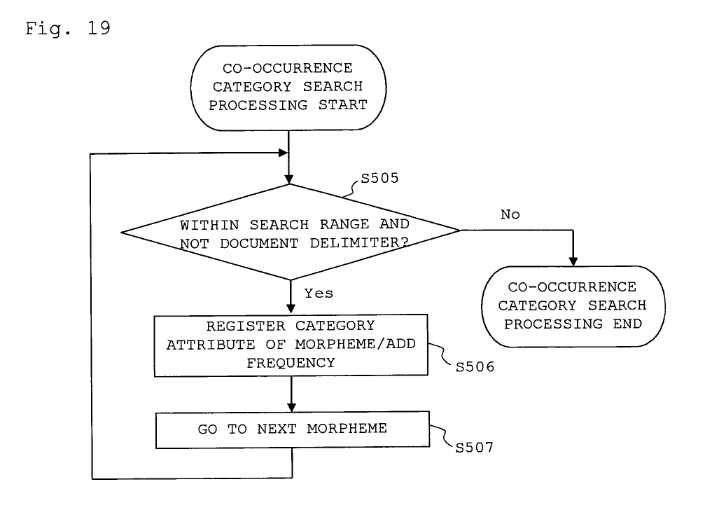

When the retrieval starts with an input retrieval word, the retrieval word is morphologically analyzed and is converted into a morpheme-ID string (step S501). Next, the category of the peripheral word co-occurring the retrieval word is registered and the co-occurrence frequency is calculated (step S502). A description will be given of this step S502 using FIGS. 18 and 19.

First, a determination is made as to whether or not all the occurrence positions of the retrieval word obtained from the occurrence-position array 350 have been processed (step S503). If there is an occurrence position of unprocessed processing, a peripheral word co-occurring before the retrieval word is retrieved in step S504 and a peripheral word co-occurring after the retrieval word is retrieved in step S508. As a representative, a description will be given of step S508 using the flowchart in FIG. 19.

First, a determination is made that the selected morpheme is within a search range after the retrieval word and is not a document delimiter at the same time (step S505). In this step, the co-occurrence range is identified as after the retrieval word. If the determination in step S505 is YES, the processing branches downward, and the category attribute of the selected morpheme is registered in the co-occurrence table to update the frequency data in the case of being unregistered with reference to the dictionaries. If registered, only the frequency data is updated (step S506). Subsequently, the next morpheme located after the selected morpheme is selected (step S507) to return to step S505. If the determination in step S505 is NO, category attributes have been registered for all the morphemes in the co-occurring range, and thus the processing branches to the right to terminate the processing. The same processing as this should be performed for step S504.

Referring back to FIG. 17, the processing proceeds to step S509, and filter processing is performed on the co-occurrence table in which the category attributes are registered. This removes the retrieval result of a low frequency such as once or twice of occurrence frequencies. In this regard, the criteria for this filtering can be increased or decreased appropriately as described above. Subsequently, as already described, a degree of co-occurrence is calculated in accordance with the selected calculation method (step S510), the categories are sorted in accordance with the degree of co-occurrence (step S511), and the result is displayed to the client. In this regard, the total frequencies of the retrieved categories can be obtained by referring to the category-attribute dictionary 310.

This retrieval result gives a ranking list of the classification categories strongly related to the retrieval word to the retrieval user. It becomes possible for the retrieval user to perform related-term retrieval using this information. In this regard, in the related-term retrieval, when although the retrieval user has input data considered to be a category name into the category-information input window 702, but the corresponding category is not found by the retrieval of the category dictionary, the processing may be automatically proceeds to related-category retrieval.

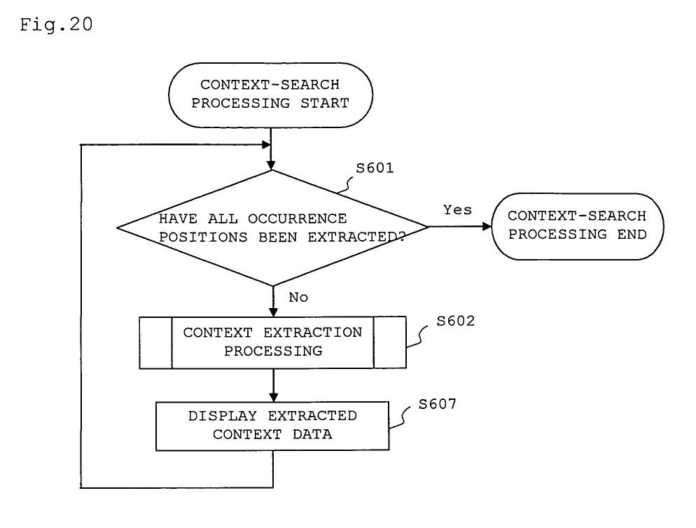

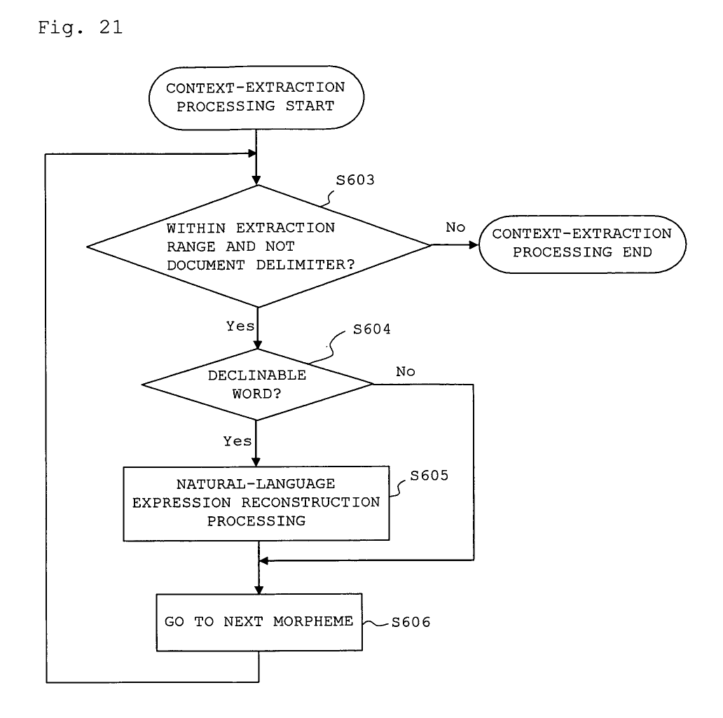

Next, a description will be given of context retrieval, which is the third retrieval shown by the selection flowchart in FIG. 8. In the context retrieval, sentences of the documents including independent words or independent word strings which are the results of related-term retrieval are retrieved. A description will be given of this retrieval using the example screen in FIG. 9, which shows the result of related-term retrieval. The independent words or independent-word strings, which are the result of related-term retrieval, are displayed with underlines in the frame 800. When each of words or strings is selected, part of the corresponding document is shown in a so-called KWIC (Key Word In Context) format in the frame 900 (shown by only the retrieval words and dotted lines in FIG. 9). This is the context retrieval. By this, the retrieval user can determine which document includes required information by viewing the relevant portion of a specific document from relationships between independent words or independent-word strings and the retrieval word. A description will be given of the processing of the context retrieval using the flowcharts in FIGS. 20 and 21.

First, a determination is made on whether or not all the co-occurrence positions have been extracted for the selected independent words or independent-word strings in the corpus array 330 (step S601). If the determination is NO, the processing branches downward, selects one unextracted co-occurrence occurrence position and extracts the context data of that co-occurrence position in the corpus array 330 (step S602). A description will be given of step S602 using the flowchart in FIG. 21. First, one morpheme is selected in the range of co-occurrence with the retrieval word, and a determination is made that the morpheme is within a search range of the retrieval word and is not a document delimiter at the same time (step S603). In this step, context extraction is performed within the range of co-occurring with the retrieval. If the determination is YES, the processing branches downward, and a determination is made on whether or not the par-of-speech of the selected morpheme is a declinable word (step S604). If the par-of-speech is a declinable word, natural-language expression reconstruction processing is performed (step S605).

This is because a bit string indicating conjugation information is provided in the fixed-length ID of a known word as shown in FIG. 5A. As is known from this, a declinable word expressed in a specific conjugation form in a document as a result of morphological analysis is stored by basic form data and conjugation type data. For example, a declinable word expressed as “Run” is stored as a basic form “run”+an “imperative form”. The natural-language expression reconstruction processing is the processing to restore the form to the original expression. In this regard, if the part-of-speech is not a declinable word, the processing in step S605 is skipped.

Next, the processing proceeds from step S605 to step S606, the restored data to the original expression is held and the processing proceeds to next morpheme to go to step S609. If the processing reaches to a document delimiter or goes out of co-occurrence range, the extraction of all the morphemes co-occurring at this occurrence position is completed, and thus the processing branches to the right and this processing is terminated.

Here, referring back to FIG. 20, the retrieval word and independent words or retrieved independent word strings in the context data extracted are highlighted or the URLs of the documents are read and added from the corresponding table between the corpus and the documents in step S607 (step S607) to return to step S601. When extraction processing of the context data is completed for all the occurrence positions, the processing branches to the right and the result is displayed to the client screen to terminate processing. Thus, it is possible to display the relevant portion by a natural-sentence expression similarly to the original expression.

By providing the three kinds of retrieval described above, the retrieval user is allowed first to perform related-category retrieval on the category to be retrieved. Next, the retrieval user is allowed to perform related-term retrieval based on the result. When the retrieval user selects related independent words or independent word strings from the displayed words or strings, the sentences of the portion in which the selected independent words or independent-word strings and the retrieval word are co-occurring are displayed by context retrieval. As a result, it becomes possible to reflect a semantic context on the retrieval condition to a certain extent. Thus, it becomes possible to perform accurate retrieval.

Next, a description will be given of the hardware configuration of an example of this retrieval system. When the system is terminated, the dictionaries and the arrays from the known-word dictionary 300 to the occurrence-position array 350 described in FIG. 1 are stored in a predetermined hard disk. The data-construction part 1 performs operations by reading only a portion necessary for the current processing out of various data and programs in the hard disk as needed and by storing various data on which processing has completed in the same manner as a normal computer.

However, the processing by the retrieval part 2 is different. When the processing by the retrieval part 2 is about to be started, the entire retrieval part including the dictionaries, the arrays, and the programs are loaded into, for example, a memory of dozens of GB to be in an on-memory state. Thus, the retrieval part 2 operates in an on-memory state including the various data. In this regard, the word “memory” used here means a storage unit such as a RAM, a flash memory, etc., capable of inputting/outputting data without mechanical operations, and the word “memory” used here does not mean a storage unit such as a hard disk, a CD-ROM, etc., which reads and writes data with mechanical operations.

At that time, it has become possible to handle a huge volume of an entire set of document files as an array by converting a set of document files into morpheme-ID strings by means of fixed-length IDs and by coding conjugational words into fixed-length IDs including conjugational information. Also, it becomes possible to restore morpheme-ID strings to natural language expressions in a memory. Thus, it becomes possible to remarkably increase the processing speed together with loading the entire portion of the retrieval processing portion into a high-speed memory to perform operations.

Of course, when performing retrieval, retrieval may be performed while accessing a low-speed storage means such as a hard disk having a lower speed, etc., as needed without using such a huge volume of memory. On the contrary, the data-construction part 1 may be constructed so as to operate on memory in the same manner as the retrieval part 2.

In the retrieval part 2 of this retrieval system, it is possible to instruct retrieval from a program of a client through a leased line. Also, the data-construction part 1 and the retrieval part 2 may be constructed on a dedicated server, and a retrieval instruction may be received from a browser of a client connected to the Internet through a Web server.

This retrieval system can be expressed as a program which is executed on a computer, and the program may be stored in a computer-readable recording medium. The program may be divided into a plurality of parts based on functions and may be stored in different recording media. Here, a recording medium refers to a removable medium such as a flexible disk, an optical disc, a ROM, a CD-ROM, a flash memory, etc., or a hard disk unit, etc.

As described above, a description has been given of embodiments of the present invention. However, the present invention is not limited to the above-described specific embodiments. For example, in the examples described above, the occurrence-position array is created for all the morphemes. However, the occurrence-position array may be limited only to independent words. Also, the occurrence-position array may be limited only to independent words of nouns. It is possible to decrease the amount of memory needed with this arrangement.

Document data included in a set of document files may be collected by an appropriate patrol server patrolling the Internet. At that time, data may be collected at random while maintaining the word order of only a word determined to be important. Alternatively, full texts may be collected. Also, the retrieval system may retrieve information from a database having a large-scale natural-language texts and connected to a LAN or a WAN without using the Internet. Examples of a set of document files include a publicly available or private database for patent specifications, various research documents, etc.

1. A retrieval system for retrieving information from a set of documents using one retrieval word or more, the system comprising:
a category dictionary for storing category information containing morphemes included in the documents in a hierarchical structure;
a morpheme-ID array produced by converting the set of documents into a set of fixed-length IDs in accordance with the morphemes while maintaining order information of the morphemes; and
a retrieval part for retrieving a morpheme ID from the morpheme-ID array,
wherein the retrieval part outputs parts of documents including the retrieval word and a morpheme co-occurring with the retrieval word and having category information matching retrieval-category information.

2. The retrieval system according to claim 1,
wherein the retrieval-category information is selected from the hierarchical structure.

3. The retrieval system according to claim 1,
further comprising a known-morpheme dictionary storing category information containing the morphemes.

4. The retrieval system according to claim 3,
wherein when the retrieval-category information is specified by a specific example, the retrieval category is identified with reference to the known-morpheme dictionary.

5. The retrieval system according to claim 3,
further comprising an unknown-morpheme dictionary storing a morpheme not stored in the known-morpheme dictionary.

6. The retrieval system according to claim 5,
wherein the unknown-morpheme dictionary is processed as one piece of the category information of the category dictionary.

7. The retrieval system according to claim 1,
wherein the co-occurring morpheme is a morpheme within a range of a predetermined number of grammatical units before and after the retrieval word.

8. The retrieval system according to claim 1,
wherein independent morphemes occurring adjacently in the document are processed by being concatenated as the co-occurring morphemes.

9. The retrieval system according to claim 1,
further comprising means for selecting a method of calculating a degree of co-occurrence for each of the co-occurring morpheme.

10. The retrieval system according to claim 1,
wherein the retrieval part calculates a degree of co-occurrence for each of the co-occurring morphemes by a method preselected and outputs a retrieval result in the order of the calculated degree of co-occurrence.

11. The retrieval system according to claim 1,
wherein all the dictionaries, the arrays, and the retrieval part are loaded into a memory for operation when retrieval processing is performed.

12. The retrieval system according to claim 11,
wherein conjugation information of the morphemes is included in the fixed-length ID.

13. An input screen of the retrieval system according to claim 1,
wherein the input screen includes an input window of the retrieval word and an input window of the retrieval category information.

14. An output screen of the retrieval system according to claim 1,
wherein the retrieval word, the retrieval category information, and the co-occurring morphemes are displayed.

15. An output screen of the retrieval system according to claim 10,
wherein the retrieval word, the retrieval category information, and the co-occurring morphemes are displayed, and the co-occurring morphemes are displayed in accordance with the calculated degree of co-occurrence.

16. The output screen according to claim 14,
further comprising display of part of the document including the co-occurring morphemes.

17. The output screen according to claim 15,
further comprising display of part of the document including the co-occurring morphemes.

18. An output screen of the retrieval system according to claim 1,
wherein the retrieval word and category information containing the co-occurring morphemes are displayed.

19. An output screen of the retrieval system according to claim 10,
wherein the retrieval word is displayed, and category information containing the co-occurring morphemes is displayed in accordance with the degree of co-occurrence.

20. A method of retrieving information from a set of documents using one retrieval word or more, the method comprising the steps of:
using a category dictionary for storing category information containing morphemes included in the documents in a hierarchical structure and a morpheme-ID array produced by converting the set of documents into a set of fixed-length IDs in accordance with the morphemes while maintaining order information of the morphemes,
retrieving a morpheme ID from the morpheme-ID array; and
obtaining a retrieval result by the morpheme IDs of the retrieval word and of any morpheme co-occurring with the retrieval word and having category information matching retrieval-category information.

21. A retrieval program for causing a computer to retrieve information from a set of documents using one retrieval word or more, the program comprising:
a category dictionary for storing category information containing morphemes included in the documents in a hierarchical structure;
a morpheme-ID array produced by converting the set of documents into a set of fixed-length IDs in accordance with the morphemes while maintaining order information of the morphemes; and
a retrieval part for retrieving a morpheme ID from the morpheme-ID array,
wherein the retrieval part outputs parts of documents including the retrieval word and a morpheme co-occurring with the retrieval word and having category information matching retrieval-category information.

22. A computer-readable recording medium storing the program according to claim 21.
